(19) United States
(12) Patent Application Publication
(10) Pub. No.: US 2021/0382694 A1
(43) Pub. Date: Dec. 9, 2021

(54) METHOD AND DEVICE FOR FINDING SQUARE ROOT

(71) Applicant: ALi Corporation, Hsinchu City (TW)

(72) Inventor: JIAN-SHIANG FANG, Taipei City (TW)

(21) Appl. No.: 17/149,857

(22) Filed: Jan. 15, 2021

(30) Foreign Application Priority Data
Jun. 5, 2020 (CN) 202010504595.X

(51) Int. Cl. G06F 7/552

(52) U.S. Cl. CPC G06F 7/552

(57) ABSTRACT

A method and a device for finding a square root are provided. The method includes the following steps: storing an unsigned integer into a first register in the form of an N-bit binary code, N being an even number greater than zero; using an operation circuit to determine whether or not the (N−1)^{th} to [N−(2×i)]^{th} bits of the unsigned integer are greater than or equal to the i^{th} integer square root; if yes, outputting 1 as the value of the [(N/2)−i]^{th} bit of the square root of the unsigned integer and storing the same into a second register; and if not, outputting 0 as the value of the [(N/2)−i]^{th} bit of the square root of the unsigned integer and storing the same into the second register, i being an integer ranging from 1 to (N/2).

### CROSS-REFERENCE TO RELATED PATENT APPLICATION

This application claims the benefit of priority to China Patent Application No. 202010504595.X, filed on Jun. 5, 2020 in People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method and device for finding a square root, and more particularly to a method and device for finding a square root that can be completed through simple bit shifting and judgment without the need of a memory to store a look-up table (LUT).

### BACKGROUND OF THE DISCLOSURE

Newton's method is a common method for finding a square root, but has the disadvantages that the number of iterations is decided by an initial value, and a divider is required. Certainly, there are other methods for finding the square root of a radicand, but these methods are more complicated and require multiplier assistance and/or a memory, such as a random access memory (RAM) to store a LUT. Therefore, as the radicand is larger, the LUT used is also larger, so that not only the required memory size increases, but the implementation of hardware also becomes more difficult.

### SUMMARY OF THE DISCLOSURE

In response to the above-referenced technical inadequacies, the present disclosure provides a method for finding a square root, including the following steps: storing an unsigned integer into a first register in the form of an N-bit binary code, N being an even number greater than zero; and then using an operation circuit to determine whether or not the (N−1)^{th} to [N−(2×i)]^{th} bits of the unsigned integer are greater than or equal to the i^{th} integer square root; if yes, outputting 1 as the value of the [(N/2)−i]^{th} bit of the square root of the unsigned integer and storing the same into a second register; and if not, outputting 0 as the value of the [(N/2)−i]^{th} bit of the square root of the unsigned integer and storing the same into the second register, i being an integer from 1 to (N/2).

In addition, an embodiment of the present disclosure provides a device for finding a square root, including a first register, a second register, and an operation circuit. The first register is configured to store an unsigned integer, and the unsigned integer is stored into the first register in the form of an N-bit binary code with N being an even number greater than zero. The second register is configured to store a square root of the unsigned integer. The operation circuit is configured to determine whether or not the (N−1)^{th} to [N−(2×i)]^{th} bits of the unsigned integer are greater than or equal to the i^{th} integer square root; if yes, the operation circuit outputs 1 as the value of the [(N/2)−i]^{th} bit of the square root of the unsigned integer and store the same into the second register; and if not, the operation circuit outputs 0 as the value of the [(N/2)−i]^{th} bit of the square root of the unsigned integer and store the same into the second register, with i being an integer from 1 to (N/2).

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a flowchart of steps of a method for finding a square root provided by a first embodiment of the present disclosure.

FIG. 2 is a function block diagram of a device for finding a square root provided by an embodiment of the present disclosure.

FIG. 3 is a flowchart of steps of a method for finding a square root provided by a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

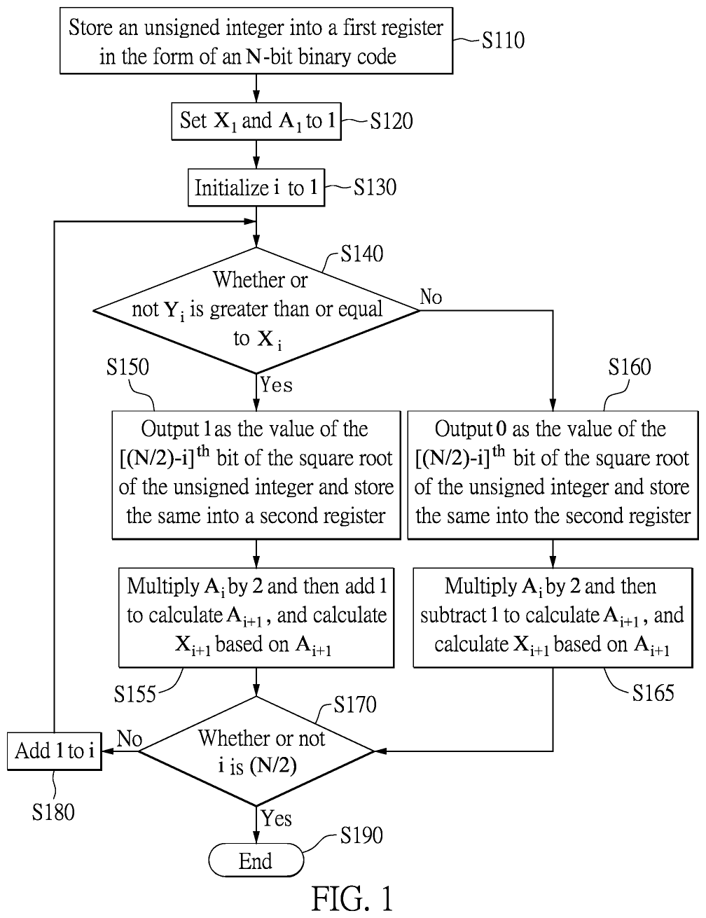

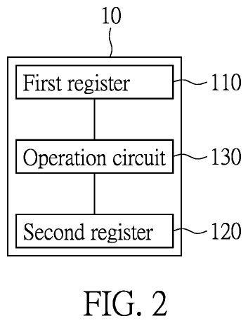

It should be noted that the method and device for finding a square root provided by embodiments of the present disclosure can be applicable to any digital communication system. In addition, because data transmitted by the digital communication system is often an unsigned integer, the method and device of this embodiment are used to find the square root of the unsigned integer. That is, the radicand of this embodiment is an unsigned integer. Reference is made to FIGS. 1 and 2 at the same time, in which FIG. 1 is a flowchart of steps of a method for finding a square root provided by a first embodiment of the present disclosure, and FIG. 2 is a function block diagram of a device for finding a square root provided by an embodiment of the present disclosure.

It should be noted that the method in FIG. 1 can be executed in a device 10 in FIG. 2, but the present disclosure does not limit that the method in FIG. 1 can only be executed in the device 10 in FIG. 2 Similarly, the device 10 in FIG. 2 is only one of implementations of the method in FIG. 1. As shown in FIG. 2, the device 10 for finding a square root can include a first register 110, a second register 120, and an operation circuit 130. The first register 110 is configured to store an unsigned integer, and the unsigned integer is stored into the first register 110 in the form of an N-bit binary code, with N being an even number greater than zero. In addition, the second register 120 is configured to store a square root of the unsigned integer. However, since the function of the register is to store a binary code, the square root of the unsigned integer in this embodiment is found in the form of a binary code.

The operation circuit 130 is coupled to the first register 110 and the second register 120, and can be implemented by means of pure hardware, or implemented by means of hardware in conjunction with firmware or software. In short, the present disclosure does not limit the specific implementation of the operation circuit 130. In this embodiment, the operation circuit 130 is configured to determine whether or not the (N−1)^{th} to [N−(2×i)]^{th} bits of the unsigned integer are greater than or equal to the i^{th} integer square root Xᵢ, with i being an integer from 1 to (N/2). Therefore, in this embodiment, it is sufficient to use (N/2) integer square roots, and the (N−1)^{th} bit of the unsigned integer represents the most significant bit (MSB) of the unsigned integer stored into the first register 110. That is, starting from the MSB of the unsigned integer stored into the first register 110, the operation circuit 130 sequentially selects (2×i) bits to compare with the i^{th} integer square root Xᵢ.

For example, in the case where N is 8, when i is 1, starting from the MSB of the unsigned integer stored into the first register 110, the operation circuit 130 first selects two bits, i.e., the seventh to sixth bits of the unsigned integer to compare with the first integer square root X₁. Secondly, when i is 2, starting from the MSB of the unsigned integer stored into the first register 110, the operation circuit 130 selects four bits, i.e., the seventh to fourth bits of the unsigned integer to compare with the second integer square root X₂, and so on. When i is 4, starting from the MSB of the unsigned integer stored into the first register 110, the operation circuit 130 selects eight bits, i.e., the seventh to 0^{th} bits of the unsigned integer to compare with the fourth integer square root X₄. Therefore, based on the increase in the number of bits sequentially selected by the operation circuit 130, the (i+1)^{th} integer square root Xᵢ₊₁ should be greater than the i^{th} integer square root Xᵢ, and compared with related arts, the input value of the present disclosure is to approximately calculate the square root of the unsigned integer from small to large.

The details about the i^{th} integer square root Xᵢ or the (i+1)^{th} integer square root Xᵢ₊₁ are illustrated in other paragraphs below, and will not be iterated here. In short, if it is determined that the (N−1)^{th} to [N−(2×i)]^{th} bits of the unsigned integer are greater than or equal to the i^{th} integer square root Xᵢ, the operation circuit 130 outputs 1 as the value of the [(N/2)−i]^{th} bit of the square root of an unsigned integer, and stores the same into the second register 120. Conversely, if it is determined that the (N−1)^{th} to [N−(2×i)]^{th} bits of the unsigned integer are not greater than or equal to the i^{th} integer square root Xᵢ, the operation circuit 130 outputs 0 as the value of the [(N/2)−i]^{th} bit of the square root of the unsigned integer, and stores the same into the second register 120. That is, the square root of the unsigned integer in this embodiment is stored into the second register 120 in the form of a (N/2)-bit binary code.

Moreover, the operation circuit 130 can take the sequentially selected (2×i) bits of the unsigned integer, i.e., the (N−1)^{th} to [N−(2×i)]^{th} bits as the i^{th} result square value Yᵢ, and the i^{th} result square value Yᵢ is equal to the square of the i^{th} integer square root Xᵢ plus the i^{th} variable value Aᵢ, that is, Yᵢ=Xᵢ²+Aᵢ. In this embodiment, the i^{th} variable value Aᵢ is an integer greater than zero, and is less than or equal to the i^{th} integer square root Xᵢ. Therefore, if the first result square value Y₁ is the most significant 2 bits of the unsigned integer, and the states of the 2 bits are “00”, “01”, “10”, or “11”, the maximum of the first result square value Yᵢ is “11”, so that the operation circuit 130 can assume that the first integer square root X₁ and the first variable value A₁ are 1. That is, before determining whether or not the (N−1)^{th} to (N−2)^{th} bits of the unsigned integer are greater than or equal to a first integer square root X₁, the operation circuit 130 is further configured to set the first integer square root X₁ and the first variable value A₁ to 1. Alternatively, to facilitate deciding the i^{th} integer square root Xᵢ, the operation circuit 130 can also calculate the square of the i^{th} variable value Aᵢ to be taken as the i^{th} integer square root Xᵢ, that is, Xᵢ=Aᵢ², but the present disclosure is not limited thereto. In short, according to the result of determining whether or not the (N−1)^{th} to [N−(2×i)]^{th} bits of the unsigned integer, i.e., the i^{th} result square value Yᵢ, are greater than or equal to the i^{th} integer square root Xᵢ, the operation circuit 130 can decide an operation mode for the i^{th} variable value Aᵢ to calculate the (i+1)^{th} variable value Aᵢ₊₁, and calculate the (i+1)^{th} integer square root Xᵢ₊₁ based on the (i+1)^{th} variable value Aᵢ₊₁. Similarly, the (i+1)^{th} variable value Aᵢ₊₁ is greater than the i^{th} variable value Aᵢ.

In this embodiment, if it is determined that the (N−1)^{th} to [N−(2×i)]^{th} bits of the unsigned integer, i.e., the i^{th} result square value Yᵢ, are greater than or equal to the i^{th} integer square root Xᵢ, the operation circuit 130 multiplies the i^{th} variable value Aᵢ by 2 and then adds 1 to calculate the (i+1)^{th} variable value Aᵢ₊₁, and calculates the (i+1)^{th} integer square root Xᵢ+i based on the (i+1)^{th} variable value Aᵢ₊₁. Conversely, if it is determined that the (N−1)^{th} to [N−(2×i)]^{th} bits of the unsigned integer, i.e., the i^{th} result square value Yᵢ, are not greater than or equal to the i^{th} integer square root Xᵢ, the operation circuit 130 multiplies the i^{th} variable value Aᵢ by 2 and then subtracts 1 to calculate the (i+1)^{th} variable value Aᵢ₊₁, and calculates the (i+1)^{th} integer square root Xᵢ₊₁ based on the (i+1)^{th} variable value Aᵢ₊₁. Therefore, as shown in FIG. 1, in step S110, the method of this embodiment first stores the unsigned integer in the form of an N-bit binary code into the first register 110. Secondly, in step S120, the operation circuit 130 sets the first integer square root Xᵢ and the first variable value A₁ to 1, and in step S130, i is initialized to 1.

Next, in step S140, the operation circuit 130 is used to determine whether or not the (N−1)^{th} to [N−(2×i)]^{th} bits of the unsigned integer, i.e., the i^{th} result square value Yᵢ, are greater than or equal to the i^{th} integer square root Xᵢ. If yes, the device 10 executes step S150 of using the operation circuit 130 to output 1 as the value of the [(N/2)−i]^{th} bit of the square root of the unsigned integer and store the same into the second register 120, and executes step S155 of using the operation circuit 130 to multiply the i^{th} variable value Aᵢ by 2 and then add 1 to calculate the (i+1)^{th} variable value Aᵢ₊₁, that is, Aᵢ₊₁=(2×Aᵢ)+1, and calculate the (i+1)^{th} integer square root Xᵢ₊₁ based on the (i+1)^{th} variable value Aᵢ₊₁; and if not, the device 10 executes step S160 of using the operation circuit 130 to output 0 as the value of the [(N/2)−i]^{th} bit of the square root of the unsigned integer and store the same into the second register 120, and executes step S165 of using the operation circuit 130 to multiply the i^{th} variable value Aᵢ by 2 and then subtract 1 to calculate the (i+1)^{th} variable value Aᵢ₊₁, that is, Aᵢ₊₁=(2×Aᵢ)−1, and calculate the (i+1)^{th} integer square root Xᵢ₊₁ based on the (i+1)^{th} variable value Aᵢ₊₁.

Then, after any of step S155 or S165 is executed, the device 10 may execute step S170 again, i.e., using the operation circuit 130 to determine whether or not the current i is (N/2); if not, the device 10 executes step S180 of using the operation circuit 130 to add 1 to i, and after 1 is added to i, the device 10 returns to step S140; if yes, the device 10 executes step S190, i.e., ending the method for finding a square root. That is, starting from i being 1, the operation circuit 130 outputs 1 or 0 as the value of the [(N/2)−i]^{th} bit of the square root of the unsigned integer according to the result of determining whether or not the (N−1)^{th} to [N−(2×i)]^{th} bits of the unsigned integer, i.e., the i^{th} result square value Yᵢ, are greater than or equal to the i^{th} integer square root Xᵢ, until the value of the 0^{th} bit of the square root of the unsigned integer is output.

However, in order to prevent a multiplier from performing complicated multiplication and division operations, the “calculating the (i+1)^{th} integer square root Xᵢ₊₁ based on the (i+1)^{th} variable value Aᵢ₊₁” in step S155 can be: multiplying the i^{th} integer square root Xᵢ by 2 and then adding the i^{th} variable value Aᵢ to calculate an intermediate value Step1, and multiplying the intermediate value Step1 by 2 and then adding the (i+1)^{th} variable value Aᵢ₊₁ to calculate the (i+1)^{th} integer square root Xᵢ₊₁, that is, Step1=(2×Xᵢ)+Aᵢ and Xᵢ₊₁=(2×Step1)+Aᵢ₊₁, but the present disclosure is not limited thereto. Similarly, step S165 can be: multiplying the i^{th} integer square root Xᵢ by 2 and then subtracting the i^{th} variable value Aᵢ to calculate an intermediate value Step2, and multiplying the intermediate value Step2 by 2 and then subtracting the (i+1)^{th} variable value Aᵢ₊₁ to calculate the (i+1)^{th} integer square root Xᵢ₊₁, that is, Step2=(2×Xᵢ)−Aᵢ and Xᵢ+i=(2×Step2)−Aᵢ₊₁, but the present disclosure is not limited thereto.

Finally, in order to further illustrate the foregoing implementations, in this embodiment, an 8-bit binary number of the unsigned integer, i.e., “10011001” is stored into the first register 110 as an example. For ease of understanding, in the following paragraphs, the corresponding decimal value is marked with parentheses after each binary number or algebra. As shown in FIG. 1, when step S140 is performed with i as 1, the operation circuit 130 determines whether or not the seventh to sixth bits of the unsigned integer, i.e., “10” (2), are greater than or equal to the first integer square root X₁ (1). Since the determination result in this case is “yes”, the operation circuit 130 outputs 1 as the value of the third bit of the square root of the unsigned integer and stores the same into the second register 120. In addition, the operation circuit 130 multiplies the first variable value A₁ (1) by 2 and then adds 1 to calculate the second variable value A₂ as 3, and calculates the second integer square root X₂ as 9 based on the second variable value A₂ (3), that is, Step1=(2×X₁)+A₁=(2×1)+1=3 and X₂=(2×Step1)+A₂=(2×3)+3=9.

Next, since i in this case is not 4, the operation circuit 130 adds 1 to i, and when step S140 is performed with i as 2, the operation circuit 130 determines whether or not the seventh to fourth bits of the unsigned integer, i.e., “1001” (9), are greater than or equal to the second integer square root X₂ (9). Since the determination result in this case is “yes”, the operation circuit 130 outputs 1 as the value of the second bit of the square root of the unsigned integer and stores the same into the second register 120. In addition, the operation circuit 130 multiplies the second variable value A₂ (3) by 2 and then adds 1 to calculate the third variable value A₃ as 7, and calculates the third integer square root X₃ as 49 based on the third variable value A₃ (7), that is, Step1=(2×X₂)+A₂=(2×9)+3=21 and X₃=(2×Step1)+A₃=(2×21)+7=49.

Similarly, since i in this case is not 4, the operation circuit 130 adds 1 to i, and when step S140 is performed with i as 3, the operation circuit 130 determines whether or not the seventh to second bits of the unsigned integer, i.e., “100110” (38), are greater than or equal to the third integer square root X₃ (49). Since the determination result in this case is “no”, the operation circuit 130 outputs 0 as the value of the first bit of the square root of the unsigned integer and stores the same into the second register 120. In addition, the operation circuit 130 multiplies the third variable value A₃ (7) by 2 and then subtracts 1 to calculate the fourth variable value A₄ as 13, and calculates the fourth integer square root X₄ as 169 based on the fourth variable value A₄ (13), that is, Step2=(2×X₃)−A₃=(2×49)−7=91 and X₄=(2×Step2)−A4=(2×91)−13=169, and so on. When step S140 is performed with i as 4, the operation circuit 130 determines whether or not the seventh to 0^{th} bits of the unsigned integer, i.e., “10011001” (153), are greater than or equal to the fourth integer square root X₄ (169).

Since the seventh to 0^{th} bits of the unsigned integer, i.e., “10011001” (153), are not greater than or equal to the fourth integer square root X₄ (169), the operation circuit 130 outputs 0 as the value of the 0^{th} bit of the square root of the unsigned integer, and stores the same into the second register 120. In addition, since the value of the 0^{th} bit of the square root is calculated in this embodiment, the operation circuit 130 can omit multiplying the fourth variable value A₄ (13) by 2 and then subtracting 1 to calculate the fifth variable value A₅ as 25, and omit calculating the fifth integer square root X₅ as 625 based on the fifth variable value A₅ (25). In short, in this embodiment, four integer square roots are sufficient, and the integer part of the square root of the unsigned integer “10011001” is “1100” (12).

In addition, in other embodiments, the operation circuit 130 can also first determine whether or not the current i is (N/2), and calculate the (i+1)^{th} integer square root Xᵢ₊₁ based on the (i+1)^{th} variable value Aᵢ₊₁ only after it is determined that i is not N/2. That is, steps S155 and S165 can be executed after step S170 is executed.

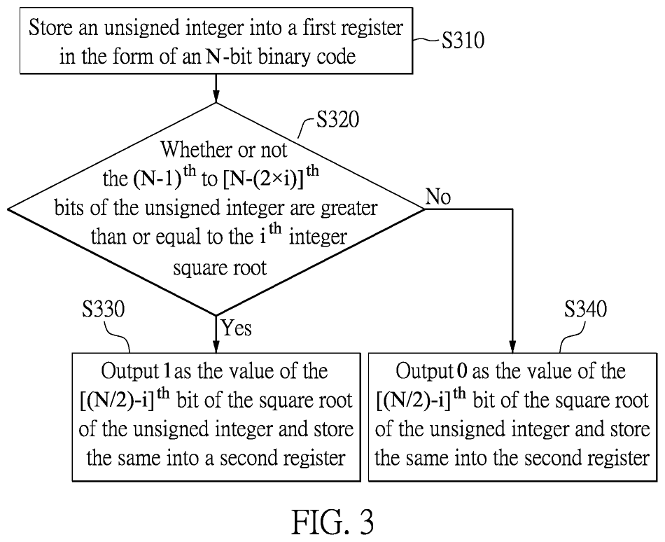

In summary, FIG. 3 is a flowchart of steps of a method for finding a square root provided by a second embodiment of the present disclosure, and the method in FIG. 3 can be executed in the device 10 in FIG. 2. As shown in FIG. 3, in step S310, an unsigned integer is stored into a first register 110 in the form of an N-bit binary code, N being an even number greater than zero. Next, in step S320, the operation circuit 130 is used to determine whether or not the (N−1)^{th} to [N−(2×i)]^{th} bits of the unsigned integer, i.e., the i^{th} result square value Yᵢ, are greater than or equal to the i^{th} integer square root Xᵢ. If yes, the device 10 executes step S330, and the operation circuit 130 is used to output 1 as the value of the [(N/2)−i]^{th} bit of the square root of the unsigned integer and store the same into the second register 120. If not, the device 10 executes step S340, and the operation circuit 130 is used to output 0 as the value of the [(N/2)−i]^{th} bit of the square root of the unsigned integer and store the same into the second register 120, with i being an integer from 1 to (N/2).

From another perspective, the method of finding a square root in the embodiments of the present disclosure can approximately calculate the square root of the unsigned integer from small to large by means of iterative operations of variable values. Each iterative operation can use different calculation methods (for example, steps S155 and S165 in FIG. 1) to determine the next variable value according to different judgment results.

In summary, the embodiments of the present disclosure provide a method and device for finding a square root, which can be completed through simple bit shifting and judgment without the need of a memory to store a look-up table (LUT), and can also use simple addition and subtraction operations to cooperate with the bit shifting operation without the need for the multiplier to perform complex multiplication and division operations. In addition, starting from the MSB of the square root, the value of one bit of the square root can be obtained for each judgment. Therefore, compared with related arts, the present disclosure is easier to implement with hardware and reduces the cost.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for finding a square root, comprising:
storing an unsigned integer into a first register in the form of an N-bit binary code, wherein N is an even number greater than zero; and
using an operation circuit to determine whether or not the (N−1)^{th} to [N−(2×i)]^{th} bits of the unsigned integer are greater than or equal to the i^{th} integer square root; if yes, outputting 1 as the value of the [(N/2)−i]^{th} bit of the square root of the unsigned integer and storing the same into a second register; and if not, outputting 0 as the value of the [(N/2)−i]^{th} bit of the square root of the unsigned integer and storing the same into the second register, wherein i is an integer from 1 to (N/2).

2. The method according to claim 1, wherein starting from i being 1, the operation circuit outputs 1 or 0 as the value of the [(N/2)−i]^{th} bit of the square root of the unsigned integer according to the result of determining whether or not the (N−1)^{th} to [N−(2×i)]^{th} bits of the unsigned integer are greater than or equal to the i^{th} integer square root, until the value of the 0^{th} bit of the square root of the unsigned integer is output.

3. The method according to claim 1, further comprising:
before determining whether or not the (N−1)^{th} to (N−2)^{th} bits of the unsigned integer are greater than or equal to a first integer square root, using the operation circuit to set the first integer square root and a first variable value to 1.

4. The method according to claim 1, wherein the operation circuit calculates the square of the i^{th} variable value as the i^{th} integer square root, and decides an operation mode for the i^{th} variable value to calculate the (i+1)^{th} variable value according to the result of determining whether or not the (N−1)^{th} to [N−(2×i)]^{th} bits of the unsigned integer are greater than or equal to the i^{th} integer square root, wherein the (i+1)^{th} variable value is greater than the i^{th} variable value.

5. The method according to claim 1, further comprising:
when determining that the (N−1)^{th} to [N−(2×i)]^{th} bits of the unsigned integer are greater than or equal to the i^{th} integer square root, using the operation circuit to multiply the i^{th} variable value by 2 and then adding 1 to calculate the (i+1)^{th} variable value, and calculating the (i+1)^{th} integer square root based on the (i+1)^{th} variable value; and
when determining that the (N−1)^{th} to [N−(2×i)]^{th} bits of the unsigned integer are not greater than or equal to the i^{th} integer square root, using the operation circuit to multiply the i^{th} variable value by 2 and then subtracting 1 to calculate the (i+1)^{th} variable value, and calculating the (i+1)^{th} integer square root based on the (i+1)^{th} variable value.

6. The method according to claim 5, wherein the step of using the operation circuit, when determining that the (N−1)^{th} to [N−(2×i)]^{th} bits of the unsigned integer are greater than or equal to the i^{th} integer square root, to calculate the (i+1)^{th} integer square root based on the (i+1)^{th} variable value comprises:
multiplying the i^{th} integer square root by 2 and then adding the i^{th} variable value to calculate a first intermediate value, and multiplying the first intermediate value by 2 and then adding the (i+1)^{th} variable value to calculate the (i+1)^{th} integer square root.

7. The method according to claim 6, wherein the step of using the operation circuit, when determining that the (N−1)^{th} to [N−(2×i)]^{th} bits of the unsigned integer are not greater than or equal to the i^{th} integer square root, to calculate the (i+1)^{th} integer square root based on the (i+1)^{th} variable value comprises:
multiplying the i^{th} integer square root by 2 and then subtracting the i^{th} variable value to calculate a second intermediate value, and multiplying the second intermediate value by 2 and then subtracting the (i+1)^{th} variable value to calculate the (i+1)^{th} integer square root.

8. A device for finding a square root, comprising:
a first register, configured to store an unsigned integer in the form of an N-bit binary code, wherein N is an even number greater than zero;
a second register, configured to store a square root of the unsigned integer; and
an operation circuit, configured to determine whether or not the (N−1)^{th} to [N−(2×i)]^{th} bits of the unsigned integer are greater than or equal to the i^{th} integer square root; if yes, the operation circuit outputs 1 as the value of the [(N/2)−i]^{th} bit of the square root of the unsigned integer and stores the same into the second register; and if not, the operation circuit outputs 0 as the value of the [(N/2)−i] bit of the square root of the unsigned integer and stores the same into the second register, wherein i is an integer from 1 to (N/2).

9. The device according to claim 8, wherein starting from i being 1, the operation circuit outputs 1 or 0 as the value of the [(N/2)−i]^{th} bit of the square root of the unsigned integer according to the result of determining whether or not the (N−1)^{th} to [N−(2×i)]^{th} bits of the unsigned integer are greater than or equal to the i^{th} integer square root, until the value of the 0^{th} bit of the square root of the unsigned integer is output.

10. The device according to claim 8, wherein, before determining whether or not the (N−1)^{th} to (N−2)^{th} bits of the unsigned integer are greater than or equal to a first integer square root, the operation circuit is further configured to set the first integer square root and a first variable value to 1.

11. The device according to claim 8, wherein the operation circuit calculates the square of the i^{th} variable value as the i^{th} integer square root, and decides an operation mode for the i^{th} variable value to calculate the (i+1)^{th} variable value according to the result of determining whether or not the (N−1)^{th} to [N−(2×i)]^{th} bits of the unsigned integer are greater than or equal to the i^{th} integer square root, wherein the (i+1)^{th} variable value is greater than the i^{th} variable value.

12. The device according to claim 8, wherein, when determining that the (N−1)^{th} to [N−(2×i)]^{th} bits of the unsigned integer are greater than or equal to the i^{th} integer square root, the operation circuit multiplies the i^{th} variable value by 2 and then adds 1 to calculate the (i+1)^{th} variable value, and calculates the (i+1)^{th} integer square root based on the (i+1)^{th} variable value; and
when determining that the (N−1)^{th} to [N−(2×i)]^{th} bits of the unsigned integer are not greater than or equal to the i^{th} integer square root, the operation circuit multiplies the i^{th} variable value by 2 and then subtracts 1 to calculate the (i+1)^{th} variable value, and calculates the (i+1)^{th} integer square root based on the (i+1)^{th} variable value.

13. The device according to claim 12, wherein, when determining that the (N−1)^{th} to [N−(2×i)]^{th} bits of the unsigned integer are greater than or equal to the i^{th} integer square root, the operation circuit multiplies the i^{th} integer square root by 2 and then adds the i^{th} variable value to calculate a first intermediate value, and multiplies the first intermediate value by 2 and then adds the (i+1)^{th} variable value to calculate the (i+1)^{th} integer square root.

14. The device according to claim 13, wherein, when determining that the (N−1)^{th} to [N−(2×i)]^{th} bits of the unsigned integer are not greater than or equal to the i^{th} integer square root, the operation circuit multiplies the i^{th} integer square root by 2 and then subtracts the i^{th} variable value to calculate a second intermediate value, and multiplies the second intermediate value by 2 and then subtracts the (i+1)^{th} variable value to calculate the (i+1)^{th} integer square root.
